(19) United States
(12) Patent Application Publication
(10) Pub. No.: US 2024/0394021 A1
(43) Pub. Date: Nov. 28, 2024

(54) SYSTEM AND METHOD FOR BUILDING SERVER-DRIVEN USER INTERFACE (SDUI) MOBILE APPLICATIONS USING NO-CODE/LOW-CODE APPLICATION BUILDER

(71) Applicant: DTCC DIGITAL (US) INC., JERSEY CITY, NJ (US)

(72) Inventors: Divyanshu Bhargava, Abu Dhabi (AE); George Daniel Doney, Riva, MD (US)

(73) Assignee: DTCC DIGITAL (US) INC., JERSEY CITY, NJ (US)

(21) Appl. No.: 18/670,273

(22) Filed: May 21, 2024

Related U.S. Application Data
(60) Provisional application No. 63/469,274, filed on May 26, 2023.

(51) Int. Cl. G06F 8/34

(52) U.S. Cl. CPC G06F 8/34

(57) ABSTRACT

The present invention is directed to a method, system, and apparatus for developing Server-Driven UI (SDUI) mobile applications using a no-code/low-code interface. The software development platform is a cross-platform application operable on mobile, desktop and web environments. The platform uses data objects to send UI logic to mobile application which uses the SDUI framework to render the data object into mobile UI. The system comprises of three main modules: the UI module, a server module, and a client module. The UI module empowers users to effortlessly design mobile UI layouts by leveraging an intuitive drag-and-drop interface for component selection and placement. The server module handles the incoming request from the mobile application and serves as a repository for mobile applications data and store the UI templates and widgets data. Meanwhile, the client module is responsible for parsing the UI logic into the native mobile UI.

### CROSS REFERENCE TO RELATED APPLICATIONS

This application claims priority to and the benefit of U.S. Provisional Patent Application No. 63/469,274, filed May 26, 2023, which is incorporated herein by reference in its entirety.

### BACKGROUND OF THE INVENTION

### 1. Field of the Invention

The present invention relates to application development, and more specifically to a no-code interface for mobile application development utilizing server-driven user interface.

### 2. Description of the Prior Art

It is generally known in the prior art to provide a low-code or no-code interface for software development.

U.S. Patent Publication No. 2023/0014590 for Method and system for providing static and dynamic inputs and advanced logging capabilities in application development systems by inventors Casaregola, et al., filed Jul. 16, 2021and published Jan. 19, 2023, is directed to a method for providing a user interface in a low-code or no-code development platform includes generating, by a computing system, a graphic user interface of an application development program. The graphic user interface includes: a first area including a list of blocks; a second area including a structured data object comprising nodes corresponding to one or more of the blocks; and a third area including a parameter field of a selected one of the nodes, wherein the parameter field is configured to receive user input defining both a static string and a dynamic variable.

U.S. Patent Publication No. 2021/0271459 for Server-driven user interface presentation framework for device application by inventors Damodharan, et al., filed Feb. 27, 2020 and published Sep. 2, 2021, is directed to systems and methods for a server-driven user interface presentation framework for device applications. A service provider server, such as an electronic transaction processor for device applications, may provide a framework where application developers and other software providers may develop user interfaces for their device-side application that may be hosted and driven to the application on a device by the service provider's server. The framework may include operations for selecting, arranging, and designing frames of a user interface, which may then be composed into a flow that allows navigation between the different frame, for example, to input data or view different information. Once created, a device side software development kit may be implemented with the application, which may be used to fetch data for, and then display, the user interface through the application.

U.S. Pat. No. 11,216,602 for Micro frontends with model-based state by inventors Bourhani, et al., filed Jun. 16, 2020 and issued Jan. 4, 2022, is directed to a computing architecture that enables users to develop applications using building blocks that include micro frontends. In one aspect, a method includes providing a configuration user interface that enables a user to select and arrange building block user interface elements in a layout for a page. Data specifying a layout of one or more building block user interface elements that each include a micro frontend and corresponding backend logic is received from the configuration user interface. Each micro frontend includes one or more user interface components and a store that manages a model that represents a state of the one or more user interface components of the micro frontend. The corresponding backend for each micro frontend includes a function that updates the model of the micro frontend based on a previous model of the micro frontend and an action. User interface data is generated.

U.S. Patent Publication No. 2022/0374213 for Spreadsheet-based software application development by inventor Stachura, filed Aug. 5, 2022, and published Nov. 24, 2022, is directed to methods and systems that may be used with local spreadsheet applications, web, and/or cloud-based spreadsheet solutions, to create complex custom software applications. Spreadsheets themselves lack the conceptual framework to be used as a platform tool to build custom or complex software applications. Using low-code/no-code techniques, a designer can create custom and/or complex software applications using one or more spreadsheets as the underlying blueprints for the software application. The resultant software application may be static/read-only, or may be interactive to allow users to dynamically add, delete, edit, or otherwise amend application data, e.g., via one or more online web pages or via a mobile application. Data transfer may be one-way or bi-directional between the blueprint spreadsheets and the resultant software application, thereby allowing amended data to be transferred from the software application back into spreadsheet form.

U.S. Pat. No. 11,442,704 for Computerized system and method for a distributed low-code/no-code computing environment by inventor Kane, filed Nov. 11, 2020 and issued Sep. 13, 2022, is directed to systems and methods for improving interactions with and between computers in content generating, hosting and/or providing systems supported by or configured with devices, servers and/or platforms. The systems and methods provide a novel low-code/no-code software development framework that enables the creation of software (e.g., applications) through graphical user interfaces and configurations instead of traditional hand-coded programming. A low code (LC) model enables developers of varied experience levels to create applications using a visual user interface in combination with model-driven logic. Similarly, a no-code model enables the development of applications without and coding on the client-side. The disclosed LCNC framework, therefore, reduces the amount of traditional hand coding, enables accelerated delivery of business applications.

U.S. Patent Publication No. 2022/0197607 for System and method for developing user interface applications by inventors Rowell, et al., filed Dec. 10, 2021 and published Jun. 23, 2022, is directed to a computer-implemented method for designing a user interface application uses a visual flow language and a model view flow architecture. The visual flow language may include components, where components include blocks and nodes. Call streams and data flows may be defined by a user. An application flow logic graph is generated. The application flow logic graph may be used to generate a user interface application.

U.S. Patent Publication No. 2021/0064349 for Systems and methods for creating enterprise software by inventors Allgeier, et al., filed Sep. 11, 2018 and published Mar. 4, 2021, is directed to technology that empowers business domain experts to create “no-code” enterprise applications with a variety of features (e.g., workflow, multi-currency, etc.). The domain expert just has to know the business and not how to code in order to create enterprise applications. In some embodiments, the domain expert can access a tool that allows the domain expert to convey intent and desires instead of providing code. The intent and desire of the domain expert can then be abstracted, translated, and stored as a metadata representation. The metadata representation can then be used to automatically generate appropriate code artifacts for the applications. The code artifacts can include snippets of code written in a variety of languages. These code artifacts can then be wrapped, using a runtime engine for example, to create the application which can be distributed to the end-users.

Amazon Web Services (AWS) Amplify, at aws.amazon.com by Amazon Web Services, Inc., describes a platform where users may build full-stack web and mobile apps in hours that are easy to start, easy to scale. Further describing a platform to create an AWS backend for your web, iOS, or android app with authentication, data, storage, and more in minutes. Further describing a platform to enable visually building a fronted UI with design-to-code Figma integration and connect the UI to a backend in clicks. Further describing a platform to enable a user to easily deploy and host fast, secure, reliable websites and server-side rendered apps in a few clicks. Further describing a platform to enable a user to extend their app with 175+ AWS services to support new use cases, DevOps practices, and user growth.

FlutterFlow, at FlutterFlow.io by FlutterFlow, Inc., describes a browser-based drag and drop interface to visually build mobile apps without writing code. Further describing a low-code builder for developing native mobile applications. Further describing a platform to enable users to use their simple drag and drop interface to build your app 10× faster than traditional development.

Wix, at Wix.com by Wix.com, Inc., describes a platform where users get complete design freedom with an Editor. Further describing a platform that enables drag and drop technology that lets one move things around their site however they'd like where every design element is customizable. Further describing the ability to resize, recolor, rotate, and align elements to make it look just right. Further describing a platform that enables users to choose from 1000's of intuitive tools and build-in features to create a professional web presence. Further describing a platform to enable a user to create a mobile app experience centered around their business and community and invite people to join as members via their own dedicated app.

Wappler, at Wappler.io by Wappler, describes a low-code software, that allows users to visually build responsive websites, mobile, and desktop apps with no vendor lock-ins and complete hosting freedom. Further describing server-side logic builder lets you visually create complex workflows without any coding. Further describing a platform that enables to connect to multiple databases, send emails, manage files and folder, process images or create login systems fully visual.

Judo, at Judo.app by Rover Labs, Inc., describes a design and build tool for SwitftUl apps that writes production-ready code for a user while the user designs. Further describing a platform that eliminates the back-and-forth with developers and free them from unrewarding grunt work. Further describing that Judo can also be used to build brand new apps. With one click, export an Xcode or Android Studio project that's ready to be submitted to the App store or Play Store.

Persona, at withpersona.com/blog/designing-app-builder-server-driven-ui by Persona Identities, Inc., describes designing an app builder with server-driven UI. Further describing a platform that enables a server to dynamically render customer components into multiple text client components depending on the selected country.

Quickbase, at Quickbase.com by Quickbase, Inc., describes a no-code platform that lets a user see, connect, and control every aspect of even a user's most complex projects. Further describing a platform with no-code app development, so a user's team can quickly and easily manage complex projects, while avoiding the cost of traditional deployment, maintenance, and development.

Uiflow, at uiflow.com by Uiflow, describes a platform to build secure and scalable fronted apps using a user's own data, UI, and integrations—all without code. Further describing the ability to design apps visually with our drag & drop interface. Further describing a platform to enable a user to Import their existing design system, or use a popular one such as Material UI.

### SUMMARY OF THE INVENTION

The present invention relates to a system for building server-driven user interface (SDUI) application utilizing a no-code/low-code application builder.

It is an object of this invention to provide a mobile application development platform that enables creation of bespoke mobile applications without the need for additional coding and implementing server-driven user interfaces.

In one embodiment, the present invention is directed to a system for developing software including a mobile device in network communication with at least one server computer; wherein the mobile device includes a software development application operable to create a mobile application; wherein the software development application includes a no-code/low-code GUI with drag and drop functionality, Server-Driven User Interface (SDUI), is hardware agnostic, and/or software agnostic; wherein the mobile application includes SDUI and/or navigation SDUI.

In another embodiment, the present invention is directed to a method for developing software including a mobile device in network communication with at least one server computer; wherein the mobile device includes a software development application operable to create a mobile application; wherein the software development application includes a no-code/low-code GUI with drag and drop functionality, SDUI, is hardware agnostic, and/or software agnostic; wherein the mobile application includes SDUI and/or navigation SDUI.

In yet another embodiment, the present invention an apparatus for developing software including a mobile device in network communication with at least one server computer; wherein the mobile device includes a software development application operable to create a mobile application; wherein the software development application includes a no-code/low-code GUI with drag and drop functionality, SDUI, is hardware agnostic, and/or software agnostic; wherein the mobile application includes SDUI and/or navigation SDUI.

The client module receives the UI template response from the server module and renders it into native UI using a rendering engine. It is engineered to cache UI templates, thereby offering offline support and mitigating the need for redundant server requests. The Client Module's capabilities extend to supporting hybrid applications, effectively parsing both server-driven and client-driven UI logic.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates a data flow diagram of the data flow in the application development platform according to one embodiment of the present invention.

FIG. 1B illustrates a data flow diagram of the data flow for application components in the application development platform according to one embodiment of the present invention.

FIG. 1C illustrates a GUI data flow diagram of data flow from the application builder to mobile devices according to one embodiment of the present invention.

FIG. 2 illustrates a desktop no-code Graphical User Interface (GUI) of the application development platform according to one embodiment of the present invention.

FIG. 3A illustrates a data flow diagram of a frontend loaded GUI according to one embodiment of the present invention.

FIG. 3B illustrates a data flow diagram of a SDUI according to one embodiment of the present invention.

FIG. 4A illustrates a schematic diagram of a computer architecture of the application development platform according to one embodiment of the present invention.

FIG. 4B illustrates a diagram of data communication between the UI module, server module, and client module according to one embodiment of the present invention.

FIG. 5 is a schematic diagram of a system of the present invention.

### DETAILED DESCRIPTION

The present invention is generally directed to an application development platform for the development of Server-Driven User Interface (hereafter “SDUI”) mobile applications employing a no-code/low-code (hereafter “NCLC” or “NC” and “LC”) interface. The present invention bridges the gap between application development and ease of use, allowing individuals without extensive programming skills to create bespoke, dynamic, and multi-platform mobile application.

In one embodiment, the present invention is directed to a system for developing software including a mobile device in network communication with at least one server computer; wherein the mobile device includes a software development application operable to create a mobile application; wherein the software development application includes a no-code/low-code GUI with drag and drop functionality, SDUI, is hardware agnostic, and/or software agnostic; wherein the mobile application includes SDUI and/or navigation SDUI.

In another embodiment, the present invention is directed to a method for developing software including a mobile device in network communication with at least one server computer; wherein the mobile device includes a software development application operable to create a mobile application; wherein the software development application includes a no-code/low-code GUI with drag and drop functionality, SDUI, is hardware agnostic, and/or software agnostic; wherein the mobile application includes SDUI and/or navigation SDUI.

In yet another embodiment, the present invention an apparatus for developing software including a mobile device in network communication with at least one server computer; wherein the mobile device includes a software development application operable to create a mobile application; wherein the software development application includes a no-code/low-code GUI with drag and drop functionality, SDUI, is hardware agnostic, and/or software agnostic; wherein the mobile application includes SDUI and/or navigation SDUI.

None of the prior art discloses a mobile application development platform operable on a mobile phone, through a mobile app, that implements a no-code interface and implements SDUI

In today's digital era, mobile applications have become a vital component of businesses, providing a medium for customers to interact with their products and services. More and more companies and entrepreneurs are recognizing the need for custom mobile applications to automate functions, facilitate transactions, and offer unique solutions to their customers. However, developing these applications often requires considerable programming expertise, which is a barrier to those who have the business understanding and inventive solutions but lack the necessary coding skills.

Even when coding expertise is available, traditional software development is time-consuming, expensive, and prone to errors and inefficiencies. The programmer may not possess the same industry knowledge as the business owner, which leads to miscommunications and delays. Frequent updates and iterations, which are essential in the ever-evolving business environment, further complicates the code and causes undesired issues, making the process even more challenging.

Developing UI applications require programming expertise, which is a significant barrier for non-technical users. Additionally, the development process is a time consuming and expensive. To address these challenges, no-code platforms have emerged, allowing users to create applications without any coding knowledge. However, most no-code platforms are limited and do not provide the solution to seamlessly update the applications. Additionally, most no-code platforms do not have the ability to create server-driven UI application.

The advent of No-Code/Low-Code (NCLC) platforms has aimed to address some of these issues by simplifying the application development process and making it more accessible. However, these platforms still have certain limitations. They often lack the flexibility and power to create complex, customized, and dynamic UIs, especially server-driven ones. Moreover, they may not support the rapid prototyping, testing, and deployment of mobile applications across different platforms and devices.

Therefore, there is a need for a method and system configured to facilitate the creation of server-driven UI mobile applications using a no-code or low-code builder, which is intuitive, efficient, versatile, and capable of addressing the above-mentioned challenges. The system should enable the design of customizable UI layouts, handle navigation, network request and data storage efficiently, support the creation of hybrid applications, and provide robust tools for versioning, testing, deployment, and analytics. This invention fulfills this need.

It has become increasingly popular for business to have their own custom mobile application (or “mobile app”) to facilitate transactions, sell products, automate functions, and otherwise provide a medium for customers to interact with their business. Additionally, it is increasingly common for entrepreneurs and inventors to conceive of inventions as having a mobile application medium to facilitating the novel functions of the invention.

However, an issue arises where the entrepreneur or inventor, while having the eureka moment and business understanding to solve a problem, does not have the required programming background necessary to see their inventive solution come to life. Furthermore, it is quite common for individuals with a comprehensive understanding of their industry to be able to come up with solutions to complex problems. However, in many circumstances these individuals do not have the required programming experience to solve these problems through a computer medium. Normally, this requires the non-programming individual to hire a programmer to code their solution for them. This is less than ideal for several reasons. First, hiring a programmer is expensive and take a considerable amount of time to find the right fit. Second, the programmer is unlikely to have the same industry background knowledge as the employer, which results in a considerable amount of time needed to convey the ideas of what the employer wants the mobile app to do. Compounding this situation with the present technological age, businesses simply cannot afford to function without computer programs, websites, or mobile apps to facilitate consumer interaction, solve business problems, and facilitate transactions.

Another problem occurs when the business owner, entrepreneur, or inventor desires to update their website or mobile app. Often, both inventing and running a business is an iterative process, in turn, the mobile app must also undergo constant updates to keep up, which results in the longer Time-to-Market. In addition to costing more time and money, the updates to the mobile app could interfere with previously written code and cause undesired issues. Following, large portions of the code may have to be rewritten, the application may need to be reviewed and tested prior to launch, and the code is further complicated for future updates. Therefore, traditional software development is beset by problems and inefficiencies.

In order to address the issues inherent in traditional software development (i.e., the process of writing code) no-code and low-code platforms have been developed to enable nonprogrammers to create bespoke applications. No-code/low-code platforms allow creation of applications through a Graphical User Interface (GUI or UI) rather than through writing lines of code. No-code development platforms are those that do not require a single line of code in order to operate. Low-code development platforms do require some programming knowledge and occasionally require additional lines of codes in order to operate. Nevertheless, those having ordinary skill in the art will understand the similarity between these two platforms-to greatly reduce the amount of code needed to create application and tailor a user interface to individuals without programming experience. Therefore, throughout this application, no-code and low-code platforms will be grouped together and referenced as such despite their minor differences, unless the context makes it clear that a difference is being struck where it is material to the present application.

No-code/low-code is a bit of a misnomer. In reality, no-code/low-code platforms require a great deal of coding, although instead of writing lines of code for a singular, specific functionality or look, no-code/low-code platforms are created to serve as a template to create other application. No-code/low-code platforms utilize small blocks of reusable code called code snippets and creating a wrapper around the code snippets, which are used to ensure compatibility and interoperability between different software structures. NCDP separates programming languages and syntax from logic to take a visual approach to software development. NCDP utilize data abstraction and encapsulation to hide the complexity of its functions from its users. Abstraction and encapsulation are complementary concepts. Conceptually, abstraction refers to a process of bringing into focus the important parts of information, while hiding or deemphasizing the unimportant parts of information. Data abstractions utilizes this concept by removing unnecessary details so that the essential information is easier to handle. Usually, this is accomplished by creating a data type or “class” that categorizes the data. Abstractions relates to how an object and its behaviors are presented to the user and encapsulation is a methodology that helps create that experience. Encapsulation refers to the bundling of data with the mechanism or functions that operate on the data. Encapsulation also restricts direct access to certain mechanism or functions of data so that users are not exposed to the innerworkings of the data. NCDP utilizes data abstraction and encapsulation to group and categorize the code snippets so that they are operable to be used together. These platforms have gained increasing popularity due to their ability to address the issues presented above.

A majority of NCDP and LCDP are run on desktop applications (i.e., software programs run locally on desktop or laptop computers) or through web-based apps (i.e., by means of a web browser, commonly through SaaS structure). However, while it may be easier to implement NCDP/LCDP onto a desktop application or web-based app, it is much more convenient to have a development platform as a mobile app operable through a mobile phone. Notably, mobile apps often must be created separately based on the operating system for the app and require the approval of the app store authority prior to being available. Additionally, desktop apps rarely require an internet connection because they are installed directly onto the computer and web-based apps are operating system agnostic because all that is required is a system that has access to a web browser. However, in many situations mobile apps are more desirable because of their accessibility (due to the abundance of mobile phones in society), their ability to send notifications to individuals while on the go, and their ability to functionally communicate with useful sensors native to smart phones (e.g., camera, microphone, speaker, location services, etc.) Desktop applications run on stationary machines or laptops, while mobile apps are designed to operate on mobile devices or tablets. In the fast-paced society we currently live in, individuals (especially entrepreneurs) are constantly on the move without access to a desktop computer. Furthermore, exceedingly more business operations and communication are accomplished through mobile devices. Therefore, it is of great benefit to have a business application, such as a NC mobile app development platform, conveniently accessible through a mobile device.

However, there are additional complications that inventors and entrepreneurs encounter when deploying mobile apps. Normally, a mobile app includes a UI that is created by a developer and packaged directly into the app while having the data rendered onto the mobile app from a remote server. Essentially, the UI is embedded into the app itself, while the data is displayed through the UI after being rendered onto the app by communication with a remote server. This becomes a problem when the mobile app owner wants to deploy their app onto conventional mobile app digital distribution platforms, such as, Apple's App store or Google's Google Play store.

This is due to the fact that prior to being accessible on a digital distribution platform, a mobile app must first be submitted, reviewed, and approved by the governing authority of the platform. Then, the mobile app must be downloaded and updated by the mobile device accessing the app. While this may not seem like a big issue initially, it becomes extremely tedious and time consuming when the entrepreneur or inventor desires to update their mobile application. Implementation of an update to a mobile app, practically restarts the process. This is because this is essentially deploying a new app. Not only does it cost time and money to develop the update, but now it must be resubmitted and approved again by the governing body. The time-consuming nature of the process is further inflated by the fact that users may not download the update to the app for some time. As a result, a device could have a version of the mobile app that is multiple iterations behind the current version, which may result in an unpleasant user experience (something undesirable from a business person's perspective). Furthermore, the owner of the mobile app does not have a proper way of gauging users' responses to the current version of the app because of the variety of app versions that may be out there.

In order to address this issue, app developers have begun to utilize Server-Driven User Interfaces (SDUI) rather than the conventional Client-Driven UI. Server Driven UI (also referred as “dynamic UI”) is a software design paradigm where the server dynamically determines the user interface of a client application. This is in contrast to a more traditional approach where the UI is primarily determined by the client-side code. In a server-driven UI, the server sends data to the client that describes what components to display and how to arrange them. This data often comes in the form of data object like a JSON or XML payload. This payload might specify what kind of component to show (e.g., a text field, an image, a button), any data to populate that component with (e.g., the text for a text field, the URL for an image), and how to arrange these components relative to each other.

An important distinction should be drawn between no-code development platforms (NCDP) and low-code development platforms (LCDP). As discussed above and hinted at by its name, LCDP may require some programming knowledge and additional code to accomplish certain, specific tasks. However, LCDP still retain the same intent as NCDP—to expedite the software development process. NCDP, as suggested by its name, does not require any coding whatsoever and is designed for individuals having zero programming experience. While there are advantages and disadvantages to both LCDPs and NCDPs, for the purposes of this application, NCDP is viewed as having an advantage to LCDPs. NCDP take LCDP one step further by fully tailoring the UI to nonprogrammers. Additionally, NCDP commonly have full drag & drop capabilities. Drag & drop refers to the interactivity of a GUI of a NCDP and is operable to allow movement on an interface (i.e., via dragging) of code snippets, visuals, or functionalities to their desired location (i.e., drop). Full drag & drop capabilities further tailors the software development experience to nonprogrammers and further facilities ease of use. Therefore, NCDPs have an advantage over LCDP in solving the problems discussed above.

Namely, when updating the UI of the mobile app, there are no actual changes to the mobile app itself, rather changes occur on the server side. This means that one does not have to submit a new version of their app to the governing authority and seek approval. Furthermore, because the update is occurring on the server side and a new version of the app is not being deployed, all devices receive the update and changes immediately and without the need for the user to manually download a new version. This is of great benefit to developers who want to know their users' reaction to updates to the application. SDUI enables immediate delivery of updates to all mobile devices running the application.

Therefore, there is a need to increase accessibility to mobile app development platforms, while implementing features to streamline the updating process. The present invention addresses such a need.

The present invention aims to bridge the gap between application development and ease of use, allowing individuals without extensive programming skills to create bespoke, dynamic, and multi-platform mobile application.

The essence of the invention is an application development platform (referred to as “platform” or “system” throughout the application) that empowers users to build applications without the need for extensive programming. This is achieved through an intuitive interface that leverages NCLC principles, providing a Graphical User Interface (GUI) with drag-and-drop functionality for building applications.

The unique characteristic of the applications created with this invention is their Server-Driven UI. Unlike traditional mobile applications, where the user interface is defined and fixed at the time of development (i.e., the client driven UI), SDUI driven mobile applications have their UI controlled by the server. This server-driven approach allows for dynamic UI updates, which are instantly pushed to the client application without the need to go through traditional application stores like app store or play store. This provides greater flexibility and responsiveness, allowing the application's UI to adapt quickly to user needs or business requirements.

Furthermore, the application development platform promotes the development of cross-platform applications. The mobile applications created using this platform are not confined to a single platform but seamlessly operates across Android, IOS, desktop, and web platforms. This multi-platform compatibility extends the reach of the applications, making them accessible to a wider audience and more adaptable to varied user preferences and requirements.

The preferred embodiment of the present invention includes a system, method, and apparatus for building server-driven UI applications using no-code/low-code application builder (the platform). The system includes three main modules: the UI module (application builder), a server module, and a client module. In one embodiment, the system is hardware agnostic, and/or software agnostic. In one embodiment, the product mobile application includes SDUI which handles Navigation, Theming, Network calls etc.

The application builder enables users to effortlessly design mobile UI layouts by leveraging no-code/low-code GUI with an intuitive drag-and-drop interface for component selection and placement. The application builder provides multiple categories of components, including basic, composite, and custom components, each offering varying levels of complexity and customizability. The application builder then generates the SDUI components of the UI logic in data object such as JSON, XML, and/or Protobuf.

The server module processes incoming request from the product mobile application and is a data repository for mobile applications, managing UI templates, widgets data, and other pertinent information of the product app. Simultaneously, the client module is operable to parse the UI logic into the native/product mobile UI. The server module preserves UI logic in a data object (e.g., JSON, XML, and/or Protobuf), which is transmitted to the client module.

The client module is operable to receive the UI template response from the server module and renders it into native UI using a rendering engine. In one embodiment, the client module is operable to cache UI templates, advantageously offering offline support and mitigating the need for redundant server requests. The Client Module's is operable to supporting hybrid applications, effectively parsing both server-driven and client-driven UI logic.

In one embodiment, the present invention is directed to an application development platform that utilizes a no-code and/or low-code (NC/LC) Graphical User Interface (GUI) to create software applications. In one embodiment, the software development platform is operable to create software application through drag and drop functionality. In one embodiment, the GUI of the software development platform includes SDUI. In one embodiment, the resulting software application includes SDUI. In one embodiment, the software development platform is hardware agnostic. In this embodiment, the software development platform is operable to run on a desktop computer, laptop computer, mobile device, and/or other computing devices. In one embodiment, the software development platform is Operating System (OS) agnostic. In this embodiment, the software development platform is operable on android OS, iOS, and/or other mobile operating systems.

In one embodiment, the application development platform is an application operable on a mobile device (i.e., a mobile app), and operable to create other mobile apps through a NC/LC GUI on the mobile device. For the sake of clarity, the GUI utilized in the mobile studio may be referred to as the “native GUI” and the GUI of the produced mobile app (i.e., the mobile app created by the application development platform) will be referred to as the “product GUI.” Similarly, the mobile application created by the application development platform will be referred to as the “product app.”

In one embodiment, the application development platform includes SDUI for the native GUI of the mobile application development platform. In this embodiment, the native GUI is a server-driven user interface. In this embodiment, the native GUI is saved on a remote server and rendered onto the GUI of the mobile device running mobile studio. In one embodiment, the application development platform is operable to enable creation of a bespoke mobile application through the native GUI. In one embodiment, the native GUI is a no-code and/or low-code interface operable to enable software development. In one embodiment, the product GUI is a server-driven user interface. In this embodiment, the product GUI is saved on a remote server and rendered onto the mobile device running the product app. In one embodiment, the application development platform includes a native GUI that is server driven and is operable to create a product app that includes a product GUI that is also server driven. In this embodiment, the application development platform includes SDUI while also being operable to create mobile apps that have SDUI. In one embodiment, the application development platform includes SDUI and is operable to create a mobile app that has front-ended UI.

In one embodiment, the application development platform is a desktop application, operable to create bespoke mobile applications. In one embodiment, the desktop application is operable to create bespoke mobile application through a NC/LC GUI of the desktop computer. In one embodiment, the desktop application includes a drag and drop interface to create bespoke mobile application. In one embodiment, the desktop application is operable to create a product app that includes SDUI.

In one embodiment, the application development platform includes a no-code graphical user interface. In one embodiment, the no-code graphical user interface enables creation of software applications without writing any code. In this embodiment, the no-code GUI includes a plurality of templates, base elements, layout elements, text boxes, layout options, scaffolds, widgets, objects, models, and/or other tools (collectively “tools”) used to create custom applications. In one embodiment, the application development platform is operable to create applications exclusively through the no-code GUI and without the need for any additional code.

In one embodiment, the application development platform includes a low-code graphical user interface. In one embodiment, the low-code GUI enables creation of software application without writing code, while enabling certain specific customization through writing additional code. In this embodiment, the low-code GUI includes the plurality of tools described above with the addition option to write additional code.

In one embodiment, the present invention includes a system and method for the creation of server-driven UI mobile applications using a no-code or low-code (NC/LC) graphical user interface (GUI). This system includes three primary components: a UI module (hereby “application builder”), a Server module, and a client module. The application builder enables users to effortlessly design mobile UI layouts by including a drag-and-drop interface for component selection and placement. The server module is operable to handles the incoming request from the product mobile application and is a repository for mobile applications data. In one embodiment, the server module stores UI templates and widgets data. Simultaneously, the client module is operable to parsing the UI logic into the native mobile UI. Advantageously, the preferred embodiment enables quick mobile app deployment onto governing bodies (e.g., Google Play Store and App Store) and instantaneous updates through its SDUI.

While various embodiments are described below one of ordinary skill in the art will understand that the application development platform is operable to be deployed on a desktop application, web-browser, and/or through a Software as a Service (SaaS) structure. Additionally, while the present application describes SDUI one of ordinary skill in the art will understand that the described methods and systems are operable with front-end UI (i.e., a user interface saved directly onto the app itself, rather than on a remote server). Lastly, while the preferred embodiment describes a product app with SDUI, one of ordinary skill in the art will understand that the application development platform is operable to produce product apps with frontend UI.

In one embodiment, the application builder is hardware agnostic. In this embodiment, the application builder is operable to run on a desktop computer, laptop computer, mobile device, and/or other computing devices. In one embodiment, application builder is Operating System (OS) agnostic. In this embodiment, the application builder is operable on Android OS, iOS, and/or other mobile operating systems.

In one embodiment, the No-Code/Low-Code (NC/LC) application builder, enables users to design mobile UI layouts with ease. In one embodiment, the application builder includes an intuitive drag-and-drop interface for component selection and placement. In one embodiment, the application builder provides components such as buttons, text fields, images, lists, maps, charts, and/or other similar components, that are customizable by changing their properties (e.g., size, color, font, text, image source, etc). In one embodiment, the platform also enables users to define the logic and data flow of the UI components using a visual programming language (VPL). In one embodiment, The UI logic is defined in Data objects, such as, JSON data, and is sent to the client devices, where it is rendered by a rendering engine that supports a plurality of UI frameworks. In one embodiment, the platform includes tools for testing, debugging, and deploying the server-driven UI applications.

In one embodiment, the application development platform includes a GUI that enables full drag and drop functionality. In one embodiment, drag and drop functionality enables selection from a list of predefined elements (i.e., code snippets), selection of a specific element or virtual object through click functionality (or press and hold functionality), and movement of the predefined element to a desired location (i.e., drag and drop). Advantageously, drag and drop functionality enables nonprogrammers to place and combine code snippets without having to write code.

In one embodiment, the platform includes a plurality of component types in the application builder that are operable to create a plurality of UI elements for mobile applications. In one embodiment, the components are classified by three categories: basic components, composite components, and custom components. Basic components are operable to display or input data, such as buttons, text fields, images, labels, switches, sliders, etc. Basic components are customized by changing their properties, such as size, color, font, text, image source, etc. Composite components are UI elements that are composed of one or more basic components and/or other composite components. Composite components provide complex and advanced functionality and appearance than basic components. For example, a list component is a composite component that contains multiple items that are operable to be scrolled vertically or horizontally. In one embodiment, each item or a composite component is a basic component and/or another composite component. A chart component is composite component that displays a charts/graph with various features, such as markers, text, zoom levels, gestures, etc. Custom components are UI elements that are created by users by combining or modifying existing basic components or composite components. Custom components provide unique and specific functionality and appearance that are not available in the predefined components. Custom components enables users of the platform to create custom design or animations in the product application.

In one embodiment, the application build includes a NC/LC GUI of the platform. In one embodiment, the application builder enables a user to build custom components using No-Code/Low-Code (NC/LC) Graphical User Interface (GUI). In one embodiment, the application enables users of the platform to create custom components by writing code into the application builder. In one embodiment, the application builder enables users to import custom components by importing the code in the application builder.

In another embodiment, the application builder includes a plurality of pre-configured application templates that enable a ready-to-use structure for mobile applications in diverse domains. These templates are operable to serve as a starting point for application development, further enhancing the efficiency of the application design process. In one embodiment, the application builder enables users to build upon, customize, modify, compile, prune, and/or add to pre-configured application templates. The application templates contain predefined UI components and layouts that are suitable for the specific app category and are customizable by the user. As a nonlimiting example, a fintech template incorporates account management, transaction history, fund transfer capabilities, and/or financial analytics. Advantageously, these templates save time, resources, and ensure a professional, user-friendly design, adaptable to specific business requirements and branding aesthetics. One of ordinary skill in the art will appreciate that this example displays the potential of the application builder to include a plurality of pre-configured application templates. In one embodiment, the application builder includes pre-configured application templates other than the fintech template.

In another embodiment, the platform is operable to utilize Artificial Intelligence (AI) to generate mobile app and/or pre-configured application templates in the application builder. In this embodiment, the AI-powered system uses machine learning algorithms and historical data to understand various application design patterns and user preferences. Based on this knowledge, the AI-powered system generates a series of application templates that are specific to and are tailored for different needs and use cases. In one embodiment, the AI system is operable to personalize the generated templates based on the individual user's preferences and past design behaviors (i.e., historical data). If a user frequently employs certain design elements or prefers a specific color scheme in their app designs, the AI-powered system is operable to take these preferences into account when generating templates for this user, advantageously providing a personalized app design experience. Further advantageously, the use of AI-powered system in generating app templates not only simplifies the application design process for users but also helps ensure that the created apps are aligned with current design trends and user preferences, enhancing the overall user experience and the potential success of the apps in the market.

In one embodiment, the platform leverages Artificial Intelligence (AI) to automate the generation and continuous updating of JSON data for server-driven user interfaces, thereby eliminating the need for traditional coding. Utilizing a combination of machine learning algorithms and real-time data analytics, the AI system analyzes user interactions, preferences, and context-specific data to dynamically generate and adjust the SDUI JSON. This JSON data, which defines the UI components and their behaviors, is automatically compiled based on the identified user needs and is substantially instantly deployable across various client devices. This not only streamlines the UI development process but also enables the UI to adapt on the fly to changing user conditions and feedback. By automating the creation and maintenance of server-driven interfaces through AI-generated JSON, this embodiment significantly enhances the responsiveness and flexibility of the application development lifecycle, providing developers and businesses with a powerful tool to rapidly deploy and update user interfaces in a highly efficient manner.

In yet another embodiment, the App Builder leverages Artificial Intelligence (AI) to transform images and UI designs directly into executable UI code, streamlining the development of user interfaces from visual concepts. The AI system employs advanced image recognition and machine learning algorithms to analyze input images—such as scanned sketches, digital mockups, or screenshots of desired interfaces—and accurately identify UI elements such as buttons, text fields, images, and layout structures. Upon recognizing these elements, the AI categorizes them and maps each to corresponding UI components in a coding framework used by the platform, such as HTML for web applications or XML for Android apps.

In one embodiment, each component has an identifier that uniquely identifies it in the JSON document and schema. In one embodiment, each component has a type that specifies its functionality and appearance. In one embodiment, the types are text, image, button, list, slider, switch, and/or other similar categorizer. In one embodiment, each component has attributes that define its properties and styles. In one embodiment, attributes are text content, font size, color, alignment, image source, button action, list items, slider range, switch state, and/or other similar component attributes. In one embodiment, each component has relationships that define its interactions with other components or external sources. In one embodiment, relationships are visibility conditions, data bindings, navigation triggers, animation effects, and/or other similar component relationships. In one embodiment, each component includes an identifier, a type, an attribute, and/or a relationship.

In one embodiment, during the UI design process, each user action in the application builder, such as adding a component, setting its property, and/or arranging its layout, is translated into a structured JSON (JavaScript Object Notation) object. This JSON object represents the blueprint of the application UI and holds essential details such as the types of components, their properties, and the relationships between them. In order to generate this JSON, the system uses a JSON schema generator tool operable to automatically generate a JSON schema based on the user actions, UI design, component properties, and/or the additional data based on each component.

In one embodiment, the generated JSON objects are stored on a server module after the UI design process is complete. The server module serves as a central repository for the product mobile application data, including the UI templates and widgets data represented as JSON objects. The server module is operable to receive requests from the product mobile application, retrieve the corresponding JSON objects, and send the JSON object back to the product mobile application. Advantageously, this server-driven approach ensures the most up-to-date UI is served to the mobile application, enabling real-time updates without the need for client-side code changes or application updates.

In one embodiment, a client module within the product mobile application is operable to parse the received JSON objects into native mobile UI. The client module is operable to interpret the JSON object and constructs the UI dynamically by creating the appropriate native components as specified in the JSON object. As a nonlimiting example, if the JSON object describes a button with a certain color and size, the client module is operable to create a native button with the specified color and size. Advantageously, this flexibility enables the server to dictate the UI changes, which the client module implements immediately, ensuring a consistent and up-to-date user experience across all devices.

In one embodiment, the client module includes a Template Rendering Engine (TRE) designed to convert the data received from the server into native UI elements. In one embodiment, the TRE houses multiple UI templates, each tailored to render a specific UI layout or element. Upon receipt of data from the server the TRE is operable to parse the data and identify the corresponding UI template for each piece of data based on their keys. These keys are unique identifiers that are associated with specific UI templates in the TRE. Once the appropriate template is identified, the TRE renders the UI elements according to the template's specifications and the parsed data (JSON object). In one embodiment, to optimize rendering performance and ensure time complexity remains constant at O(1) regardless of the number of templates, the TRE is operable to employ a hashmap data structure to store the UI templates. In this embodiment, each template is stored as a key-value pair in the hashmap, with the key being the unique identifier and the value being the template itself. Advantageously, this enables the TRE to quickly and efficiently retrieve the necessary template by its key, effectively bypassing the need to iterate over a list of templates and significantly reducing rendering time. The use of a TRE in this manner streamlines the UI rendering process, enhances the performance of the application, and provides a smooth and responsive user experience, even as the complexity and number of UI templates and/or components increases.

In one embodiment, the platform is operable to parse other data representation formats other than JSON in combination to JSON data. In one embodiment, the platform is operable to utilize XML (Extensible Markup Language), Protobuf (Protocol Buffers), and/or other data representation format that describe the structure and properties of the UI designs.

In one embodiment, the system uses XML (Extensible Markup Language) as data representation object instead of JSON. XML is a markup language that defines a set of rules for encoding documents in a format that is both human-readable and machine-readable. XML uses tags to delimit elements and attributes to define their properties. The XML string is operable to be parsed by the client app and rendered into native views using a rendering engine.

In one embodiment, the system uses protobuf as the data representation object instead of JSON. Protobuf is a binary format that defines a set of rules for serializing structured data. This format is particularly useful for complex UI designs as it provides more efficient data storage and faster data transmission than text-based formats like JSON and XML. Protobuf uses .proto files to specify the schema of each message type and generates source code for various languages to encode and decode the messages. The .proto file is compiled by the protocol buffer compiler and generate source code for various languages to encode and decode the messages. The product application uses the generated source code to parse and render the messages into native views using a rendering engine.

In one embodiment, the invention includes a preview mode in the application builder, enables users to visualize and interact with the UI design in real-time. As users design the UI layout by selecting, placing, and configuring components, the application builder renders an immediate representation of the design within a virtual mobile device frame. This live preview reflects the appearance and behavior of the application as it would be experienced on an actual device. The application builder is operable to enable users to interact with the preview, testing functionality such as button presses, form submissions, and navigation between different views, providing valuable feedback during the design process. The preview feature supports different device profiles, emulating various screen sizes, orientations, resolutions, and operating system to ensure the application design is responsive and adaptable. In one embodiment, the preview feature reflects changes in real-time as users modify properties of components, reposition elements, and/or add new components. Advantageously, the preview feature eliminating the guesswork and fosters a more efficient design process. This live preview capability allows users to iterate and refine their UI design rapidly, ensuring optimal user experience and design fidelity when the mobile application is deployed.

In one embodiment, the application development platform incorporates robust versioning support for mobile applications created within the application builder, which simplifies the management of multiple app iterations. Given the inherent structure of SDUI apps, where UI layouts and elements are dynamically rendered based on server responses, managing different versions of UI templates becomes crucial. In one embodiment, each new version of a UI template or component is assigned a unique identifier, included in server responses, enabling the client module to render the correct version. As an example, if a user is running an older version of the mobile application that does not support certain features or components introduced in newer versions of the UI templates, the server module is operable to send an older version of the UI template that is compatible with the user's application. Advantageously, the versioning support enhances compatibility and flexibility; the server module is operable to provide versions compatible with different client application capabilities or user preferences. In one embodiment, where a user's application version does not support newer UI template features, the server module sends a compatible older version. Conversely, updated apps receive newer UI templates from the server module to utilize enhanced capabilities. Advantageously, versioning aids in debugging and troubleshooting by enabling isolation of issues to specific template versions, thus improving manageability and scalability.

In one embodiment, the system is operable to utilize gRPC (Google Remote Procedure Call) protocol to handle communications between the server and client modules. gRPC is a high-performance, open-source framework developed by Google that uses protocol buffers as its interface definition language. gPRC allows for the definition of services and message types, which is automatically compiled to code in various languages, enhancing the compatibility and interoperability of the system. In one embodiment, the server module uses gRPC to send responses to the client module. When a client module sends a request for a specific UI template, the server module retrieves the required data, constructs a response containing the UI template data, and sends it back to the client module using gRPC. Advantageously, this enables efficient, compact, and fast communication between the server module and client modules, improving the overall performance and responsiveness of the system. Furthermore, gRPC supports both synchronous and asynchronous communication, allowing the system to handle multiple requests and responses simultaneously without blocking. This enhances the scalability of the system and enables it to support a large number of concurrent users. Additionally, gRPC's support for bi-directional streaming and flow control allows for even more efficient communication, as large UI templates are operable to be streamed piece by piece from the server to the client, reducing the memory footprint and increasing the speed of UI rendering.

In one embodiment, the client module is designed to enhance the system's offline usability. In one embodiment, the client module is operable to cache the UI template responses received from the server module. When the server module sends a UI template response, the client module stores a copy of this data (cache). This cached version is then used when the client is unable to communicate with the server, such as during periods of network unavailability or intermittent connectivity. The client module ensures that users are able to continue to interact with the product mobile application in an offline mode, even when they are unable to connect to the server. In one embodiment, when the mobile application is launched or a specific screen is navigated to, the client module first checks for the availability of the network. If the network is unavailable, the client module fetches the cached version of the UI template for rendering the interface. If the network becomes available again, the client module is operable to contact the server to update the cached UI templates, ensuring that the user always has access to the most recent versions of the interface when online, while still providing a robust offline experience.

In one embodiment, the client module is designed to optimize its communication with the server module to further enhance the efficiency of the system. When the client module needs to fetch a UI template, it is operable to first check its cache to determine if a version of the requested UI template is already stored. In one embodiment, the client module keeps track of the version of the cached UI template. If the client module finds that the cached version is the same as the requested version, it will not send a request to the server module to fetch the UI template rather, it will use the cached version to render the UI. This not only conserves network resources and improves the speed of the UI rendering but also reduces the load on the server module, enhancing the overall performance and responsiveness of the system. This feature is particularly beneficial in scenarios where the UI of a mobile application does not change frequently, or where the user navigates between screens that use the same version of a UI template. By effectively utilizing the cached UI templates, the platform ensures a smoother and faster user experience, while also minimizing unnecessary network communication and server load.

In one embodiment, the system is designed to be platform-agnostic, enabling the generated product mobile applications to function seamlessly across a variety of platforms. The client module, responsible for rendering the UI of the mobile application, utilizes platform-agnostic coding techniques and libraries to translate the server-driven UI data into native UI elements specific to each platform. This cross-platform capability is achieved through the use of frameworks such as React Native or Flutter, which provide a unified Application Programming Interface (API) for creating UI components that are rendered into the native controls of each platform. Consequently, a mobile application designed with the system is able to be deployed on IOS, Android, and other mobile platforms, without requiring separate codebases or significant alterations. This feature ensures a consistent user experience across various platforms, without sacrificing the performance or native feel of the application. It also significantly reduces the development and maintenance costs, as a single codebase and UI design is operable to serve multiple platforms. In one embodiment, updates or changes to the application are implemented simultaneously across all platforms, ensuring feature parity and a uniform experience for all users, irrespective of their device's operating system.

In one embodiment, the system exhibits a robust hardware-agnostic nature. This means that the system is able to generate server-driven UI mobile applications that are capable of running on a wide array of hardware devices. Whether it be a smartphone, tablet, or any other mobile device, the system is operable to accommodate various hardware configurations and capabilities, such as different screen resolutions, processing power, memory, and storage capacity. The hardware agnostic feature of the system is achieved through the use of abstract UI templates and components that are translated into native UI elements by the client module. This translation process is sensitive to the particularities of the hardware device on which the application is running. For example, a UI layout designed in the application builder renders differently on a smartphone with a small screen and a tablet with a large screen, to provide the best user experience on each device. This simplifies the development process, as users do not need to create separate versions of the application for different hardware devices.

In one embodiment, the system enables a way to add and customize actions such as performing navigation, network calls, storage, etc. Actions are operations that are operable be performed by the client application in response to user interactions or events. Actions are operable to be used to implement the logic and functionality of the UI, such as a button click, a form submission, or a page load. In one embodiment, the system provides a way to add and customize actions using the GUI of application builder. In one embodiment, the application builder includes a library of predefined actions that enables developers to choose from or create their own custom actions using the graphical user interface. As an example of this functionality, a button component is configured with an action that navigates to a different page within the application when it is clicked.

In one embodiment, the system includes actions (e.g., navigation actions, network call actions, and storage actions). In one embodiment, the system includes network actions and/or storage action. Navigation actions enable movement between different pages or sections within the application. Navigation actions are operable to be triggered by components such as buttons or links. Navigation actions also specify the navigation style, transition style, direction, etc. In one embodiment, the platform enables the client product application to communicate with external data sources or services using network protocols such as HTTP or gRPC. In one embodiment, network actions are triggered by components such as forms or lists. In one embodiment, network actions specify the request method, headers, body, parameters, and/or response handling for each network call. In one embodiment, storage actions allow the client app to store or retrieve data locally on the device. In one embodiment, storage actions are triggered by components such as inputs or checkboxes. In one embodiment, storage actions specify the key, value, mode, and expiration for each storage operation.

In one embodiment, application builder includes an intuitive interface for creating and configuring these actions. The application builder enables users of the platform to select from a list of predefined actions, or define custom actions using a scripting language or a visual programming interface. The system enables users to specify when and how these actions are triggered, providing fine-grained control over the application's behavior. By providing this capability, the system empowers users to create dynamic, interactive applications without needing to write or understand complex programming code. This significantly reduces the technical barriers to mobile application development and opens up the process to a wider range of users.

In one embodiment, the system enables a way to add and customize actions by using data representation objects (such as JSON, XML, or protobuf) to define them. The system uses data representation objects to define the actions as message types that contain the type, attributes, and parameters of each action. The system enables a way to add and customize actions such as performing navigation, network calls, storage, etc. by sending them to the client product application for execution from the server. In one embodiment, the client product application uses a generic container to parse and render the UI template response and execute the actions using native frameworks and libraries.

In one embodiment, the system is operable to facilitate A/B testing for applications designed with the application builder. A/B testing, also known as split testing, is a method of comparing two versions of an app to see which one performs better. A/B testing is a way to test changes to an application's user interface against the current design and determine which one produces better results. In one embodiment, the system's server module is configured to serve different versions of the UI template to different groups of users. In one embodiment, the server module is operable to handle this distribution despite it being random, or being based on certain user attributes or behaviors. In one embodiment, the UI templates represent different design alternatives for the same application feature. For example, one template could have a blue “Buy Now” button, while another template could have a red “Buy Now” button. Alternatively, the templates could represent different user flows or navigation structures.

In one embodiment, the system includes a mechanism for embedding analytics capabilities within the applications created via the application builder. In one embodiment, this is achieved by providing analytics components within the builder itself, which is seamlessly integrated into the application design. In one embodiment, an analytics component is a special type of component available in the application builder. When added to a UI layout, it would be configured to track certain user interactions or events, such as button clicks, form submissions, page views, and so forth. These events could be defined and customized by the user during the app design phase. Once the application is deployed and in use, the analytics component would collect data about the tracked interactions. This data would then be sent back to the server module, either in real-time or in batches at regular intervals. The server module could store this data in a dedicated analytics database, or it could forward it to a third-party analytics service, as configured by the user. In one embodiment, the system includes a dashboard or similar interface for viewing and analyzing the collected analytics data. This interface could offer various data visualization options, such as graphs, charts, and tables. In one embodiment, the system provides filtering and sorting features, allowing users to explore the data and gain insights about their application's usage and performance. This enables users to make data-driven decisions and continuously improve their applications based on user behavior and feedback.

In one embodiment, the no-code/low-code platform incorporates a continuous integration/continuous deployment (CI/CD) pipeline, automating the application development process from code commit to deployment. Integrated with version control systems like Git, the application builder enables tracking and version management of UI and backend changes. Upon code submission, the pipeline automatically triggers a suite of tests—unit, integration, and UI tests—to ensure robustness and functionality across different devices. Successful tests lead to automated builds and deployments, which are operable to be configured to stage or production environments via strategies like blue-green deployments or canary releases. Additionally, real-time monitoring post-deployment allows for immediate feedback and data-driven enhancements, thereby maintaining the application's performance and user relevance. This streamlined integration of CI/CD not only accelerates the development cycle but also enhances operational efficiency and reduces time-to-market, providing significant advantages in rapidly changing market conditions. This integration ensures that developers focus on innovation and user experience while the system manages the complexities of testing, building, and deployment processes.

Referring now to the drawings in general, the illustrations are for the purpose of describing one or more preferred embodiments of the invention and are not intended to limit the invention thereto.

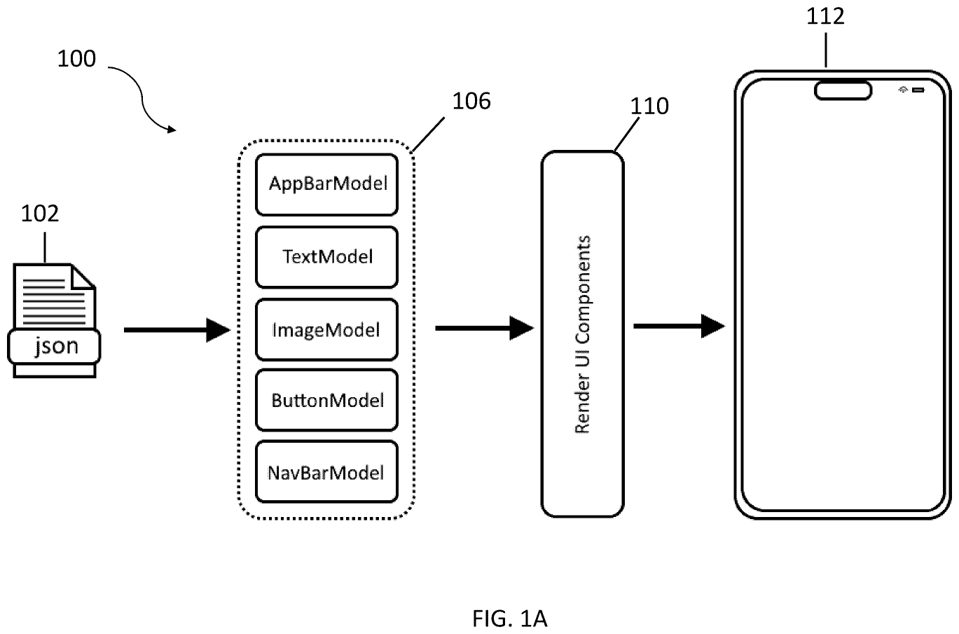

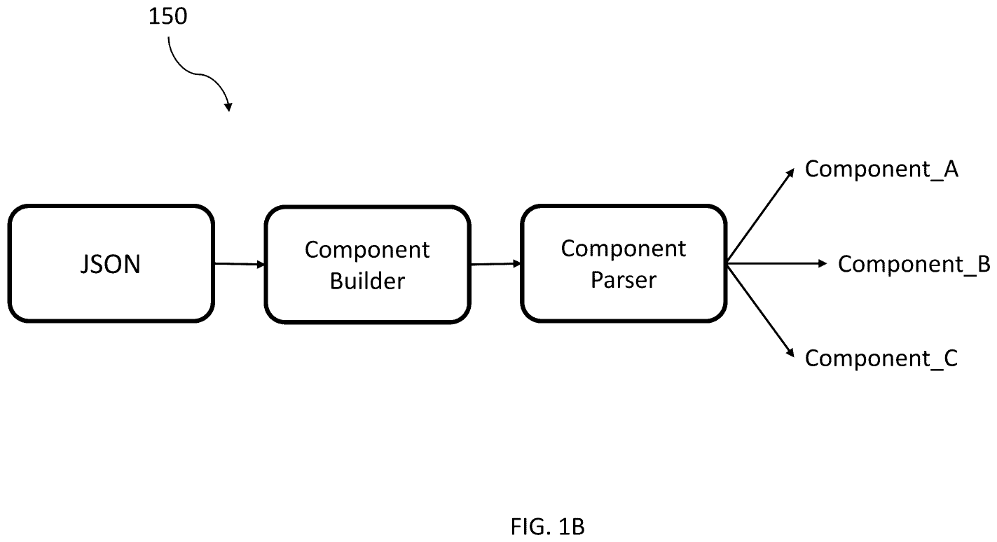

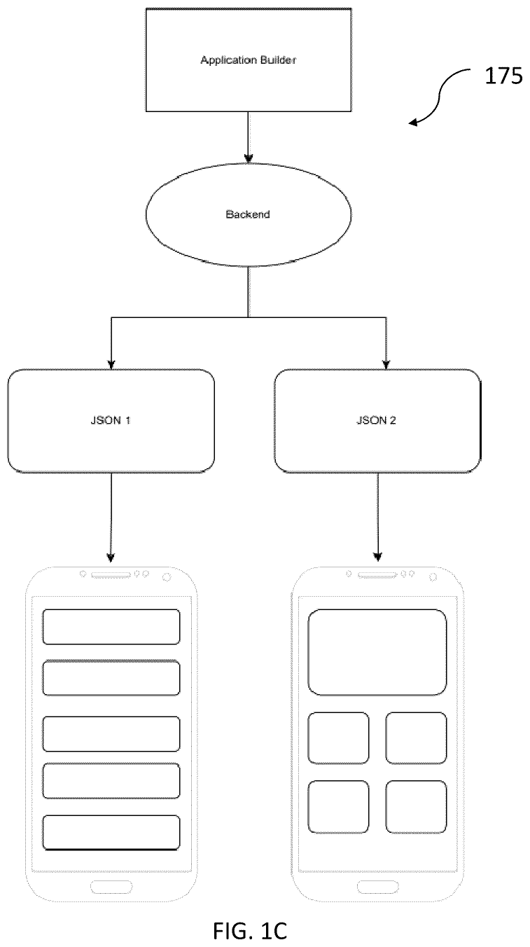

FIG. 1A illustrates a data flow diagram of the data flow in the mobile studio 100 according to one embodiment. In one embodiment, the flow of data in the mobile studio 100 includes a JavaScript Object Notation (JSON) 102 file, a UI model 106, rendered UI components 110, and a mobile device 112.

FIG. 1B illustrates a data flow diagram of the data flow for mobile app components 150 in the mobile studio 100 according to one embodiment of the present invention. In one embodiment, the mobile studio 100 is operable to build and parse components for a mobile app utilizing JSON data. In one embodiment, the JSON data is forwarded to the component builder and then to the component parser. In one embodiment, the component parser is operable to parse data from the component builder to produce a plurality of individual components.

FIG. 1C illustrates a GUI data flow diagram 175 of data flow from the application builder to mobile devices according to one embodiment of the present invention. In one embodiment, the application builder is operable to facilitate JSON data from the backend (i.e., server side) to a mobile device. In one embodiment, the application builder is operable to facilitate a plurality of JSON data to a plurality of mobile devices.

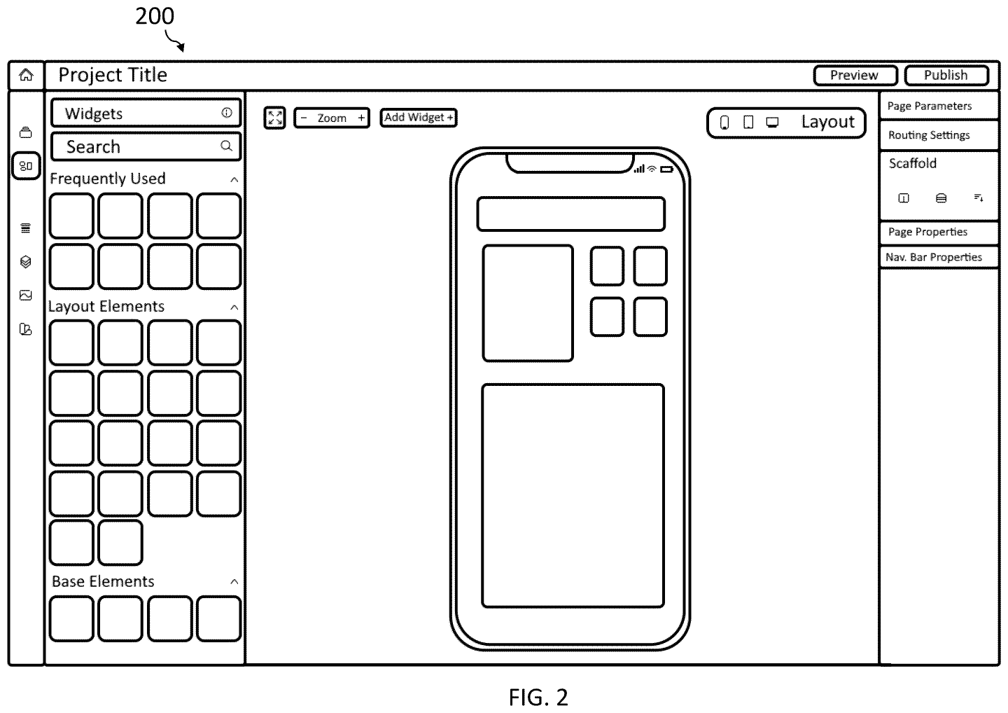

FIG. 2 illustrates a desktop no-code Graphical User Interface (GUI) 200 of mobile studio according to one embodiment. In one embodiment, the mobile studio is operable on a desktop computer. In this embodiment, mobile studio includes a no-code GUI 200 specifically for desktop implementation. In this embodiment, the no-code GUI 200 includes a number of widgets and tools that enable creation of bespoke mobile apps. In one embodiment, the desktop no-code GUI 200 includes a product GUI preview, a widget panel, a properties panel, tool bar, navigation bar, and/or a number of functional buttons.

In one embodiment, the product GUI preview displays a screen of a mobile device running the product app. Advantageously, the product GUI preview enables an understanding of the look and feel of the product GUI prior to deploying the product app. In one embodiment, the product GUI preview displays a dynamic look of the product app, which continuously updates the product GUI as new components, texts, widgets, and elements are added. In one embodiment, the product GUI preview is operable to receive elements through a drag and drop mechanism. In one embodiment, the product GUI preview is operable as a “drop” location for elements in the desktop no-code GUI 200.

In one embodiment, the widget panel is an interactive interface that includes a plurality of widgets/elements. In one embodiment, the widget panel separates elements and widgets by category. Advantageously, the widget panel provides selection from a list a premade element and widgets to use in creating the product app. In one embodiment, the widget panel is operable to provide elements through a drop and drop mechanism. In one embodiment, the plurality of widgets and elements are operable to be “dragged” to a specified location in the desktop no-code GUI 200. In one embodiment, the widget panel includes a search bar, functional to receive text input to search for specific widgets by key word. In one embodiment, the widget panel includes layout elements. In one embodiment, layout elements contain one or more widget in a single element (i.e., as a widget family, widget child, or widget parent). In one embodiment, layout elements provide a means to apply multiple, related widgets at once. In one embodiment, the widget panel includes base elements. In one embodiment, base elements are widgets that consist of text, images, buttons, dropdown buttons, slider, and similar basic elements needed for app development. In one embodiment, the widget panel includes page elements. In one embodiment, page elements include widgets that are applied to multiple pages of the product app at once. In one embodiment, an applied page element is consistent throughout the different GUIs of the product app. An a nonlimiting example, a page element is a navigational bar with navigational buttons that enables navigation between different GUI pages of the product app. In this example, the navigational bar is visible on every GUI page of the product app. In one embodiment, the widget panel includes form elements. In one embodiment form elements includes text field, dropdown fields, credit card forms, ratings bar, and/or other similar form elements.

In one embodiment, the properties panel is operable to alter and/or modify the characteristics of the product app, product GUI, and plurality of widgets added to the product GUI preview. In one embodiment, the properties panel provide a means to customized selected widgets. Advantageously, the properties panel provide a means to specifically tailor the widgets of the desktop no-code GUI 200. In one embodiment, the properties panel is operable to alter a selected widget's visual appearance, padding, alignment, positioning, size, and/or other properties.

In one embodiment, the tool bar includes options and buttons to navigate the desktop no-code GUI 200. In one embodiment, the tool bar includes a layout option, which is operable to change the layout of the product GUI preview. In one embodiment, the layout options includes an option to change the layout of the product GUI preview to represent that of a mobile phone, tablet, and/or desktop GUI of the product app. In one embodiment, the tool bar includes focus options, operable to zoom in or out on the product GUI preview. In one embodiment, the tool bar includes a preview button operable, upon selection, to display the product app in a way identical to how it will be displayed once it is deployed. In one embodiment, the tool bar includes a product app deploy button operable, upon selection, to deploy and/or activate the product app based on the changes made to it by the desktop no-code GUI 200.

In one embodiment, the navigation bar includes a plurality of navigational buttons. In one embodiment, the plurality of navigational buttons are operable to transition the GUI of the desktop no-code GUI 200 to different GUI pages.

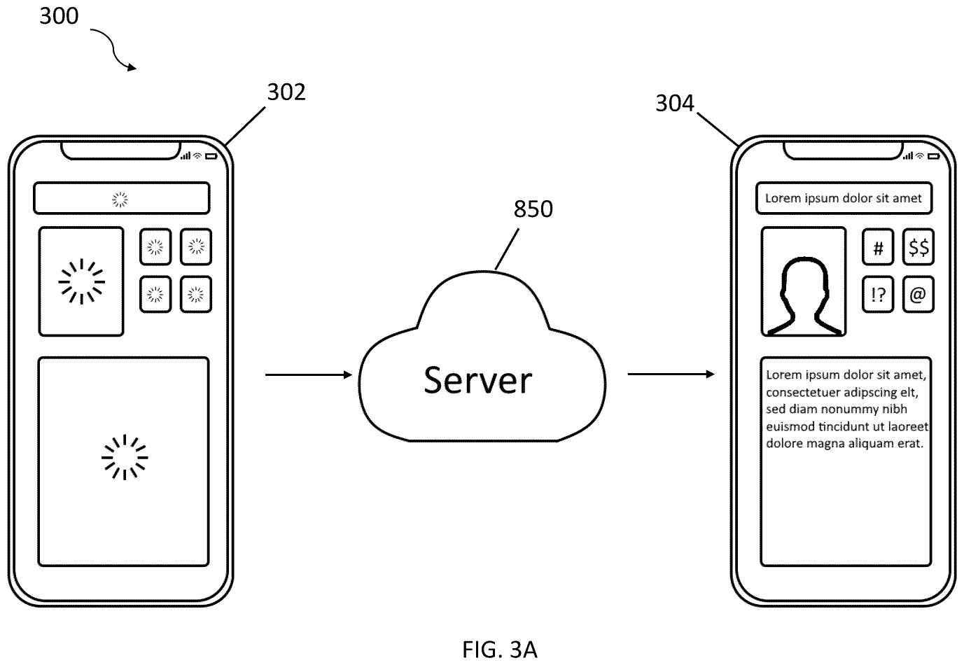

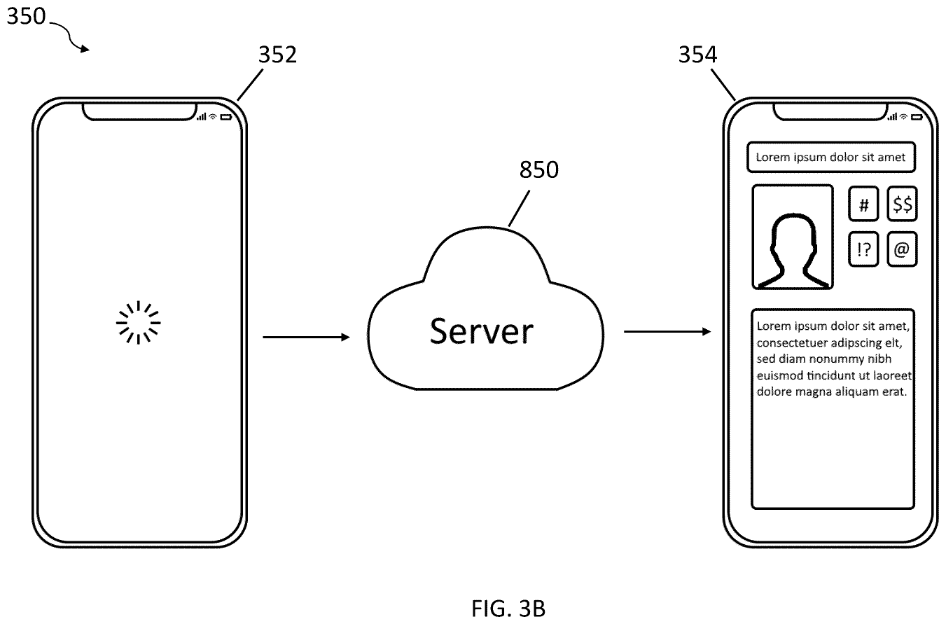

FIG. 3A illustrates a data flow diagram of a frontend loaded GUI 300 according to one embodiment. In one embodiment, the mobile studio is operable to create product apps that include a frontend loaded GUI. In this embodiment, the elements that compose the GUI of the product app are saved directly onto the mobile device running the mobile app (as indicated in FIG. 3A at 302) while the data used to fill the GUI of the product app are saved onto a remote server 850. In this embodiment, the product app is operable to request information data from the remote server 850, to be rendered and displayed on the product app 304.

FIG. 3B illustrates a data flow diagram of a Server-Driven User Interface (SDUI) 350 according to one embodiment. In one embodiment, the mobile studio includes a GUI that is server-driven. In one embodiment, the SDUI of the mobile studio is saved onto a remote server 850 and rendered onto the mobile device running the mobile studio. In one embodiment, the mobile studio is operable to request information data and visualization data (e.g., information needed to display the GUI) from a remote server 850 and render both the visualization data and the information data onto the GUI of the mobile device running the mobile studio 354. In one embodiment, the data flow of a SDUI 350 begins with a mobile device running mobile studio 352 sending a request to a remote server 850 to receive information and visual data. Following, the remote server 850, upon receiving the request, sends both the information data and visual data to the mobile device running mobile studio, where the mobile device renders the information resulting in the visual and information data being displayed on the GUI of the mobile device 354.

In one embodiment, the product app includes a GUI that is server-driven. In one embodiment, the SDUI of the product app is saved onto a remote server 850 and rendered onto the mobile device running the product app. In one embodiment, the product app is operable to request information data and visualization data (e.g., information needed to display the GUI) from a remote server 850 and render both the visualization data and the information data onto the GUI of the mobile device running the product app. In one embodiment, the data flow of a SDUI begins with a mobile device running product app sending a request to a remote server 850 to receive information and visual data. Following, the remote server 850, upon receiving the request, sends both the information and visual data to the mobile device running product app, where the mobile device renders the information resulting in the visual and information data being displayed on the GUI of the mobile device.

In one embodiment, the mobile studio 100 is operable to include component based SDUI. In one embodiment, the components (components and widgets are used interchangeably) of the product app are saved onto a remote server and rendered onto the product GUI. In one embodiment, the components of the mobile studio are saved onto a remote server and rendered onto the native GUI.

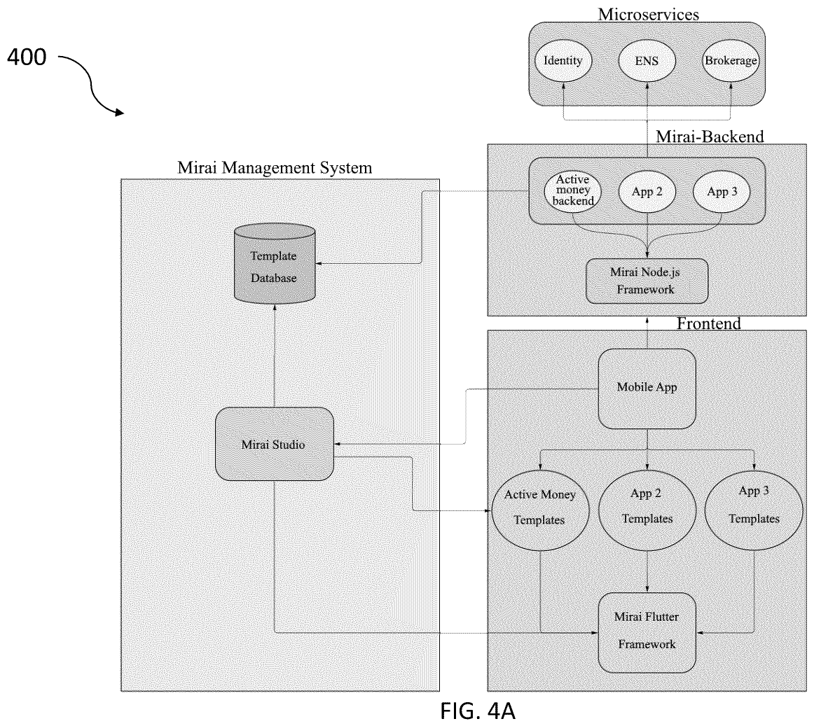

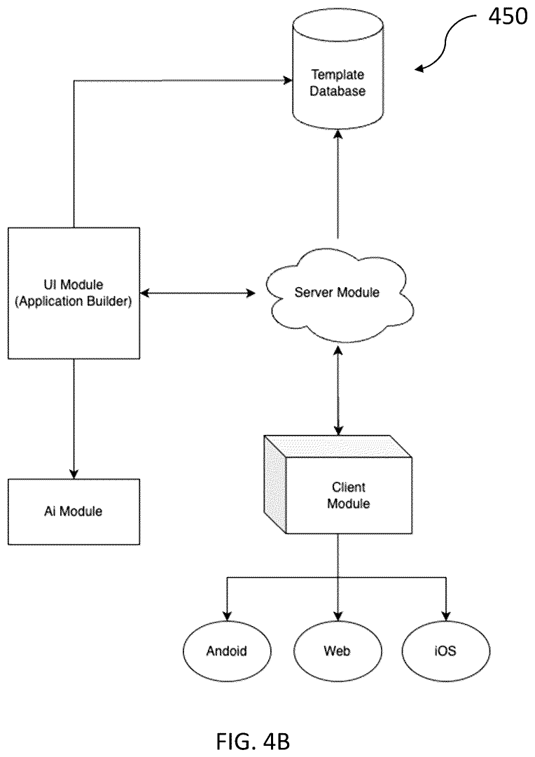

FIG. 4A illustrates a schematic diagram of a computer architecture 400 of the mobile studio according to one embodiment of the present invention. In one embodiment, the computer architecture 400 includes a Mirai Management system, a microservices computer module, a Mirai-backend computer module, and a frontend computer module. In one embodiment, the Mirai Management system includes a template database, operable to store a plurality of templates for use in the product app.

FIG. 4B illustrates a diagram 400 of data communication between the UI module, server module, and client module according to one embodiment of the present invention. FIG. 4B illustrates the communication protocol that enables the described functions of the present invention. In one embodiment, the server module is operable to functionally communicate with a template database, the application builder, and/or the client module. In one embodiment, the application builder (UI module) is in communication with the template database and at least one AI module. The AI module utilizes machine learning algorithms and historical data to understand various application design patterns and user preferences as further described above in the specification. In one embodiment, the client module is operable to communicate with on a web-based application, an android operating system and/or an iOS operating system.

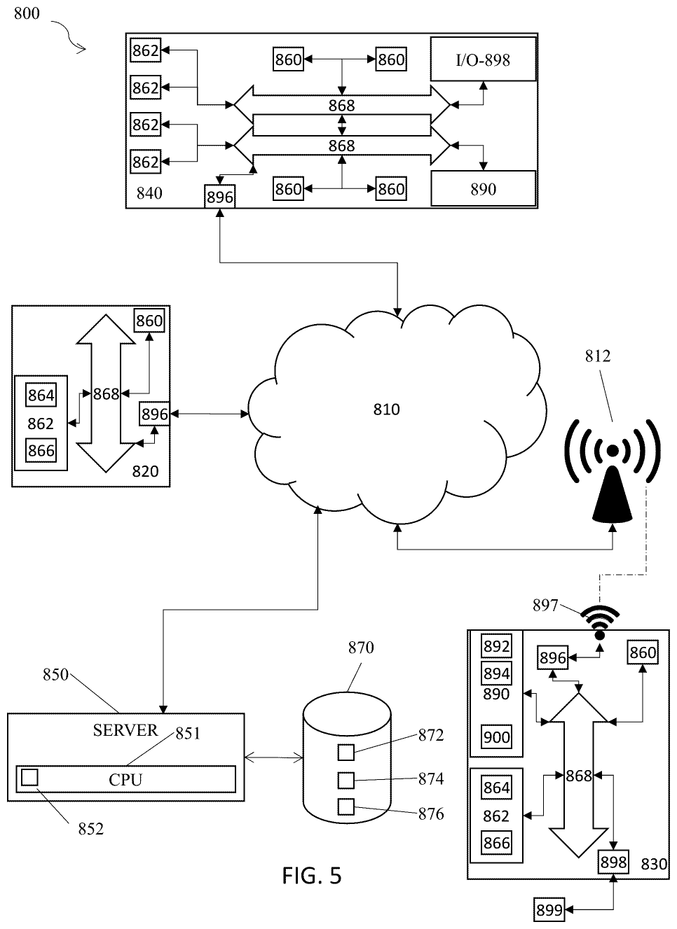

FIG. 5 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof perform calculations, process instructions for execution, and/or other manipulations of information.

In another implementation, shown as 840 in FIG. 5, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that is operable to be used to store the computer readable instructions and which is operable to be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 5, is operable to include other components that are not explicitly shown in FIG. 5, or is operable to utilize an architecture completely different than that shown in FIG. 5. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The application development platform is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The application development platform is operable to use any of the aforementioned learning techniques alone or in combination.

Further, the application development platform is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The application development platform is preferably operable to recommend and/or perform actions based on historical data, external data sources, ML, AI, NNs, and/or other learning techniques. The application development platform is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for no-code and low-code development of software applications, comprising:
a server with a server processor and a server memory with a server database;
a user device, with a device processor and a device memory with a device database;
wherein the server hosts a platform with a platform user interface (UI), wherein the user device is configured to access the platform and display the platform UI on a display of the user device;
wherein the platform UI displays a plurality of code snippets, wherein the plurality of code snippets are pre-programed into the platform;
wherein the platform UI receives an input from the user device, wherein the input includes a selected code snippet; and
wherein the selected code snippet is incorporated into a software application, wherein the software application is developed on the platform and hosted on the server.

2. The system of claim 1, wherein the platform is configured to receive an update input from a user device, wherein the update input includes a selected updated code snippet, wherein the platform is configured to automatically update the software application based on the selected updated code snippet.

3. The system of claim 1, wherein the plurality of code snippets of the present invention are operating system agnostic, wherein the software application is configured to operate seamlessly across dissimilar operating systems.

4. The system of claim 1, wherein the platform is configured to render the plurality of code snippets into a native UI of the user device using a rendering engine.

5. The system of claim 1, wherein the software application is a server-driven user interface (SDUI).

6. The system of claim 1, wherein the software application is a hybrid application which incorporates at least one server-driven code snippet implementing server-driven logic and at least one client-driven code snippet implementing client-driven logic.

7. The system of claim 1, wherein the user device transmits a bespoke code snippet to the platform, wherein the bespoke code snippet comprises a new series of code, wherein the plurality of code snippets does not include the new series of code.

8. The system of claim 1, wherein the platform includes at least one template, wherein the at least one template comprises a plurality of structural code snippets, wherein the structural code snippets code for an application framework.

9. The system of claim 1, wherein at least one of the plurality of code snippets is a data representation object, wherein the data representation object is a JSON, an XML payload, or a protobuf payload.

10. The system of claim 1, wherein the selected code snippet is updated via a server facing interface to produce an updated code snippet, wherein the software application is automatically updated to include the updated code snippet.

11. A method for no-code and low-code development of software applications, comprising:
a server hosting a platform with a platform user interface (UI), wherein the server comprises a server processor and a server memory with a server database;
the user device accessing the platform and displaying the platform UI on a display of the user device, wherein the user device comprises a device processor and a device memory with a device database;
the user device creating a software application via the platform, comprising the steps of;
the platform UI displaying a plurality of code snippets to the display of the user device, wherein the plurality of code snippets are pre-programed into the platform;
the user device selecting a code snippet of the plurality of code snippets via an interactive input and dragging the selected code snippet to an application builder module of the platform UI;
the application builder module receiving the selected code snippet from the user device;
the platform incorporating the selected code snippet into the software application, wherein the software application is developed on the platform and hosted on the server; and
the platform building the software application incorporating the selected code snippet, wherein the software application is saved on the server as a server-driven user interface (SDUI); and
the user device selecting an additional code snippet of the plurality of code snippets, wherein the platform is configured to automatically update the software application to incorporate the additional code snippet.

12. The method of claim 11, further comprising the platform rendering the plurality of code snippets, the selected code snippet, and the additional code snippet into a native UI of the user device using a rendering engine.

13. The method of claim 11, further comprising the user device transmitting a bespoke code snippet to the platform, wherein the bespoke code snippet comprises a new series of code, wherein the plurality of code snippets does not include the new series of code.

14. The method of claim 11, further comprising the platform updating the selected code snippet via a server facing interface to produce an updated code snippet, wherein the software application is automatically updated to include the updated code snippet.

15. The method of claim 11, further comprising the platform displaying at least one template, wherein the at least one template comprises a plurality of structural code snippets, wherein the structural code snippets code for an application framework

16. The method of claim 11, further comprising the platform processing a transaction, wherein upon completion of the processing of the translation, the platform is configured to enable the user device to select at least one paid code snippet.

17. A system for no-code and low-code development of software applications, comprising:
a server with a server processor and a server memory with a server database;
a user device, with a device processor and a device memory with a device database;
wherein the server hosts a platform with a platform user interface (UI), wherein the user device is configured to access the platform and display the platform UI on a display of the user device;
wherein the platform further comprises a server module, a client module, and an application builder module, wherein the server module is configured to communicate with the client module and wherein the application builder module displays a code for a software application;
wherein the platform UI receives a plurality of code snippets from the server module, wherein the client module of the server receives the plurality of code snippets from the server module and translates them into a native UI of the user device, wherein the platform UI displays the translated code snippets to the display of the user device;
wherein the plurality of code snippets are predefined, wherein the plurality of code snippets are displayed as predefined elements on the platform UI;
wherein the platform receives an input from the user device, wherein the input includes a selected code snippet of the plurality of code snippets, wherein the platform UI is configured to transmit the selected code snippet to the application builder module of the platform UI;
wherein the application builder module incorporates the selected code snippet into the code for the software application; and
wherein the code for the software application is saved on the server as a server-driven user interface (SDUI).

18. The system of claim 17, wherein the platform receives an update to the selected code snippet via a server facing interface to produce an updated code snippet, wherein the code of the software application is automatically updated to include the updated code snippet.

19. The system of claim 17, wherein the platform receives an additional code snippet of the plurality of code snippets, wherein the platform is configured to automatically update the code of the software application to incorporate the additional code snippet.

20. The system of claim 17, wherein the platform is hardware agnostic and operating system (OS) agnostic.
